(19) United States
(12) Patent Application Publication
(10) Pub. No.: US 2024/0291302 A1
(43) Pub. Date: Aug. 29, 2024

(54) DEVICE WITH CHARGING MECHANISM

(71) Applicant: Nicoventures Trading Limited, London (GB)

(72) Inventors: Damyn MUSGRAVE, London (GB); Conor BRUTON, London (GB); Mohammed AL-AMIN, London (GB)

(21) Appl. No.: 18/568,949

(22) PCT Filed: Jun. 10, 2022
(86) PCT No.: PCT/GB2022/051458

§ 371 Date: Dec. 11, 2023

(30) Foreign Application Priority Data
Jun. 11, 2021 (GB) 2108378.7

(51) Int. Cl. H02J 7/00; A24F 40/50; A24F 40/95; H02J 50/20; H02J 50/80

(52) U.S. Cl. CPC H02J 7/0044; A24F 40/50; A24F 40/95; H02J 7/00034; H02J 50/20; H02J 50/80

(57) ABSTRACT

A non-combustible aerosol provision device is described comprising a contact-based charging mechanism for coupling with a contact charging device for contact charging of the aerosol provision device and a wireless charging mechanism (e.g. a radio frequency charging mechanism) for coupling with a wireless charging device for wireless charging of the aerosol provision device. Furthermore, a charging device is described comprising a contact-based charging mechanism for coupling with a first device for contact charging of the device in a contacting charging mode and a wireless charging mechanism for coupling with a second device for wireless charging of the device in a wireless charging mode.

### RELATED APPLICATIONS

The present application claims priority to PCT Application No. PCT/GB2022/051458 filed Jun. 10, 2022, which claims priority to GB Application No. 2108378.7 filed Jun. 11, 2021, each of which is herein incorporated by reference in their entirety.

### TECHNICAL FIELD

The present specification relates to a device (such as an aerosol generating device) with charging mechanism(s).

### BACKGROUND

Aerosol generating devices, such as an e-cigarettes, have been developed for releasing compounds without requiring combustion. Such devices often include rechargeable batteries. There remains a need for further developments in the charging of such devices.

### SUMMARY

In a first aspect, this specification describes a non-combustible aerosol provision device (such as an electronic smoking article) comprising: circuitry for controlling the supply of power within the aerosol provision device; a contact-based charging mechanism for coupling with a contact charging device for contact charging of the aerosol provision device; and a wireless charging mechanism (e.g. a radio frequency charging mechanism) for coupling with a wireless charging device for wireless charging of the aerosol provision device, wherein the circuitry is configured to control the supply of power within the aerosol provision device received via the contact-based charging mechanism and via the wireless charging mechanism.

The contact-based charging mechanism may comprise at least two first contact charging pads for coupling with a contact charging device. The wireless charging mechanism may comprise at least one wireless charging pad for coupling with a wireless charging device. The contact charging device and the wireless charging device may be the same or different charging devices. The wireless charging pads may be radio frequency charging pads for coupling with a radio frequency charging device for radio frequency charging of the device.

In some example embodiments, one or more (e.g. all) of said the first contact charging pads are dual-charging pads for use as either contact charging pads or wireless charging pads and the at least one wireless charging pad is implemented using one or more (e.g. all) of said dual-charging pads. The dual-charging pads may be metal pads that are operable as one or more antennas (e.g. etched antennas).

The at least two first contact charging pads may be provided on a first side of the device. The device may further comprise at least two second contact charging pads provided on a second side of the device (which second side may be substantially opposite the first side). Alternatively, or in addition, the first contact charging pads may be accessible from both the first side of the device and a second side of the device (e.g. the first contact charging pads may extend around the device).

In embodiments have first and second sides, those first and second sides may form part of the same surface of the device.

The device may be configured to transmit data via one or more of said charging mechanisms (e.g. using a data over power protocol). For example, data may be transmitted using one or more charging pads (e.g. contact charging pads, wireless charging pads and/or dual-charging pads).

In a second aspect, this specification describes a charging device comprising: a contact-based charging mechanism for coupling with a first device for contact charging of the device in a contacting charging mode; a wireless charging mechanism for coupling with a second device for wireless charging of the device in a wireless charging mode; and a control module configured to set a charging mode of the charging device to the contact charging mode or the wireless charging mode. The first and second devices may be the same device or different devise. The wireless charging mechanism may be a radio frequency charging mechanism for coupling with the second device for radio frequency charging of the device.

The contact-based charging mechanism may comprise at least two charging points for coupling with at least two contact charging pads of the first device. For example, the contact-based charging mechanism may comprise a mat having a plurality of contact charging points for coupling with charging pads of the first device. Alternatives to a mat include a pot or a trough or just multiple (e.g. two) exposed contact charging points.

The control module may be configured to determine whether a device is in contact with at least two charging points of the contact-based charging mechanism and to set the charging mode accordingly.

The wireless charging mechanism may comprise one or more first wireless charging pads.

The charging devices may further comprise one or more dual-charging pads for use during contact of the device in the contact charging mode and for use during wireless charging of the device in the wireless charging mode. The dual-charging pads may be metal pads that are operable as one or more antennas (e.g. etched antennas).

In a third aspect, this specification describes a method comprising: determining whether a contact based charging mechanism of a charging device having the contact-based charging mechanism and a wireless charging mechanism is configured for contact charging of a device for charging and, if so, enabling a contact-based charging mode of operation of the charging device. The charging device may comprise dual-charging pads for use as either contact charging pads or wireless charging pads.

The method may comprise enabling a wireless charging mode of operation of the charging device in the event that the wireless charging mechanism is not configured for contact charging the device for charging.

The method may comprise determining whether the wireless charging mechanism of the charging device is configured for charging of the device for charging and, if so, enabling a wireless charging mode of operation of the charging device. The method may further comprise transmitting data to and/or receiving data from the device for charging via said contact based charging mechanism and/or the wireless charging mechanism.

In a fourth aspect, this specification describes computer program product comprising instructions for causing an apparatus to perform: determining whether a contact based charging mechanism of a charging device having the contact-based charging mechanism and a wireless charging mechanism is configured for contact charging of a device for charging and, if so, enabling a contact-based charging mode of operation of the charging device.

### BRIEF DESCRIPTION OF THE DRAWINGS

Example embodiments will now be described, by way of example only, with reference to the following schematic drawings, in which:

FIG. 1 is a block diagram of an aerosol generating device in accordance with an example embodiment;

FIG. 2 is a flow chart showing an algorithm in accordance with an example embodiment;

FIG. 3 is a block diagram of a system in accordance with an example embodiment;

FIG. 4 is a block diagram of a charging mat in accordance with an example embodiment;

FIG. 5 is a block diagram of a device in accordance with an example embodiment;

FIG. 6 is a cross-section system showing a device being charged in accordance with an example embodiment;

FIG. 7 is a block diagram of a system in accordance with an example embodiment;

FIG. 8 is a block diagram of a system in accordance with an example embodiment;

FIG. 9 is a block diagram of a system in accordance with an example embodiment;

FIG. 10 is a cross-section of a system in accordance with an example embodiment;

FIG. 11 is a cross-section of a system in accordance with an example embodiment;

FIG. 12 is a flow chart showing an algorithm in accordance with an example embodiment;

FIG. 13 is a block diagram of a device in accordance with an example embodiment;

FIG. 14 is a block diagram of a device in accordance with an example embodiment;

FIGS. 15A to 15D are cross-sections of devices in accordance with example embodiments;

FIG. 16 is a flow chart showing an algorithm in accordance with an example embodiment; and

FIG. 17 is a block diagram of a charging device with an example embodiment.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

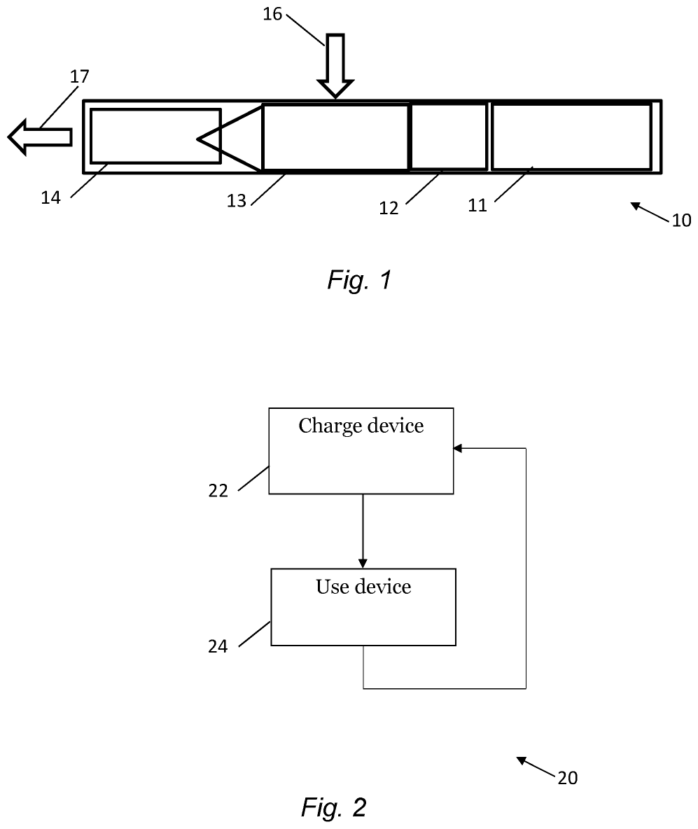

FIG. 1 is a block diagram of an aerosol generating device, indicated generally by the reference numeral 10, in accordance with an example embodiment.

The aerosol generating device 10 comprises a battery 11, a control circuit 12, an aerosol generator which in this example is a heater 13 and an aerosol-generating material storage area which in this example is a liquid reservoir 14. As discussed in detail below, the battery 11 may be rechargeable.

In the use of the device 10, air is drawn into an air inlet of the heater 13, as indicated by arrow 16. The heater 13 is used to create an aerosol by heating liquid drawn from the liquid reservoir 14. In some devices that user ceramic heaters, liquid is wicked by micro-fluidics of the porous heater material, and in some other devices, a dedicating wicking material (such as fibrous cotton) may be provided to which liquid to the heater 13. The aerosol exits the device at an air outlet, as indicated by arrow 17 (for example into the mouth of a user of the device 10).

Of course, the aerosol generating device 10 is provided by way of example only and is highly schematic. Many alternative aerosol generating devices and other devices may be used in example implementations of the principles described here.

FIG. 2 is a flow chart showing an algorithm, indicated generally by the reference numeral 20, in accordance with an example embodiment.

The algorithm 20 starts at operation 22, where a battery of a device, such as the aerosol generated device 10 described above, is charged. At operation 24, the device is used. Use of the device may include any such use of the device which requires electrical power (e.g. from the battery) and is not limited solely to aerosol generation. A number of arrangements are possible for charging the device in the operation 22. The device 10 is able to return to the charging operation 22, for example when the battery 11 is fully or partially depleted. In some example embodiments, it may be advantageous to allow the device to be charged whilst the device is being used. The device 10 is able to return to the charging operation 22, for example when the battery 11 is fully or partially depleted. In some example embodiments, it may be advantageous to allow the device to be charged whilst the device is being used.

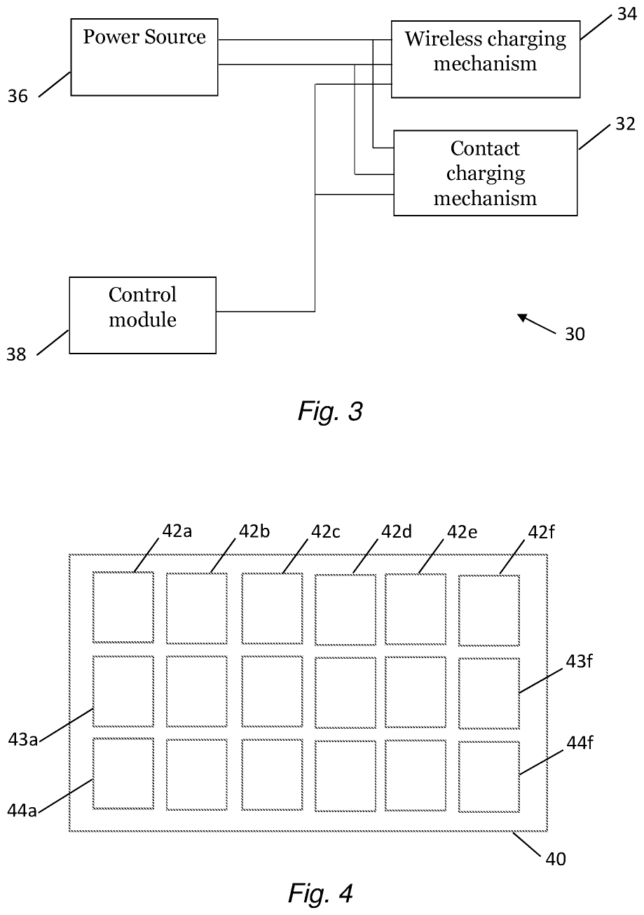

FIG. 3 is a block diagram of a system, indicated generally by the reference numeral 30, in accordance with an example embodiment. The system 30 may form part of a charging device, for example for charging a device such as an aerosol generating device.

The system 30 comprises a contact charging mechanism 32, a wireless (e.g. radio frequency) charging mechanism 34, a power source 36 and a control module 38. The system 30 may include a single charger implementing both the contact charging mechanism 32 and the wireless charging mechanism 34 or two discrete chargers (one implementing the contact charging mechanism 32 and another implementing the wireless charging mechanism 34).

The power source 36 provides power to both the contact charging mechanism 32 and the wireless charging mechanism 34. The control module 38 controls the operation of the contact and wireless charging mechanisms. For example, the control module 38 may be configured to set a charging mode of the system 30 to a contact charging mode (in which the contact charging mechanism 32 is activated) or a wireless (e.g. radio frequency) charging mode (in which the wireless charging mechanism 34 is activated). Alternatively, the control of selection between charging method may be implemented at the device to be charged.

The contact-based charging mechanism 32 is provided for coupling with a device (such as an aerosol generating device) for contact charging of the device in a contacting charging mode of operation. Similarly, the wireless charging mechanism 34 is provided for coupling with a second device (such as an aerosol generating device) for wireless charging of the device in a wireless charging mode of operation. Thus, the system 30 may be configured to use the contact charging mechanism 32 for charging a first device through contact charging and to use the wireless charging mechanism 34 for charging a second device through wireless (e.g. RF) charging. Furthermore, as discussed in detail below, the system 30 may be used to charge a dual charging device that can be charged using either contact charging or wireless charging, as appropriate (that is, the first and second device may be the same device).

As discussed further below, the contact-based charging mechanism 32 may comprise at least two contact charging pads for coupling with a contact charging device and the wireless charging mechanism 34 may comprises one or more radio wireless charging pads for coupling with a wireless charging device. In one example embodiment, multiple wireless charging pads are used together to form a single antenna of a wireless charging mechanism.

The wireless charging pads may implement a patch antenna that can be also be used as contact charging pads.

FIG. 4 is a block diagram of a charging mat 40 in accordance with an example embodiment. The charging mat 40 may be used to charge a battery of a device through contact charging and may therefore provide the contact charging mechanism 32 of the system 30 described above.

The mat 40 comprises a plurality of contact charging points. A first row of contact charging points 42a to 42f is labelled in FIG. 4. A second row of contact charging points includes contact charging points 43a to 43f (of which only contact charging points 43a and 43f are labelled) and a third row of contact charging points 44a to 44f (of which only contact charging points 44a and 44f are labelled).

The mat 40 may have more or fewer contact charging points than those shown in FIG. 4. For example, the mat may have any number of rows and each row may have any number of contact charging points. Moreover, the distribution of contact charging points may be different to that shown in the mat 40; for example, different rows may include different numbers of contact charging points.

Each contact charging point may be coupled with a contact charging pad of a device to be charged. More specifically, the mat 40 comprises at least two charging points for coupling with at least two contact charging pads of a device to be charged.

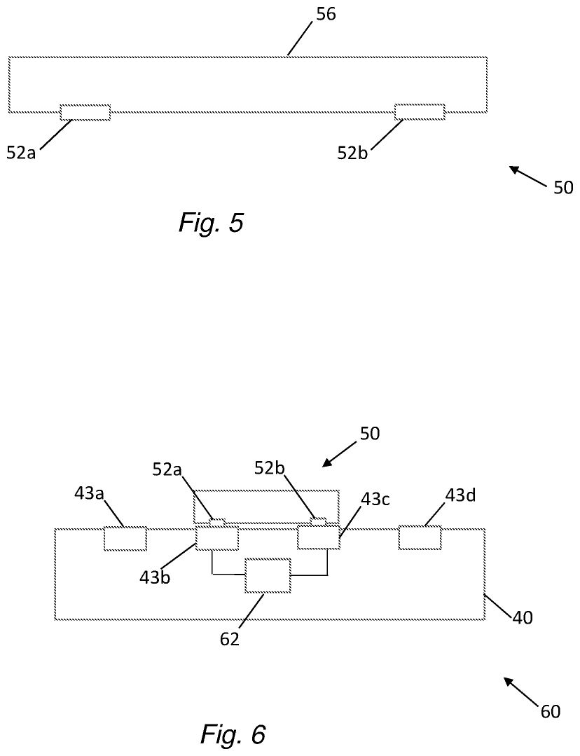

FIG. 5 is a block diagram of a device, indicated generally by the reference numeral 50, in accordance with an example embodiment. The device 50 is an device (such as an aerosol generating device) having a first side and a second side (which sides are opposite one another in the example device 50). A pair of first contact charging pads 52a and 52b are provided on the first side of the device 50. In the example of FIG. 5, the device 50 is elongated and the pair of contact pads 52a and 52b are provided at or adjacent to the respective ends of the device in the direction of elongation. However, other configurations of the device (e.g. non-elongated configurations) are possible. Moreover the “sides” on which the contact charging pads are provided may be different to those shown in FIG. 4; for example, the contact charging pads may be provided on the ends of the device 40, with the first pair of contact charging pads being provided on one end and the second pair of contact charging pads being provided on the other end.

The charging pads 52a and 52b of the device 50 are arranged such that an area or point on each of the contact charging pads lie in or on a first common plane. The device 50 includes a housing 56, wherein the housing lies below said common planes such that the contact charging pads are able to make contact with contact charging points of a charging mat, such as the mat 40 described above.

It should be noted that the device 50 is provided by way of example only and many alternative arrangements are possible. For example, although the device 50 provides a flat planar surface comprising charging contacts, this is not essential to all example embodiments. The principles described herein are applicable to a range of geometries where the charging device and the device being charged are not flat.

The device 50 may be an aerosol provision device (such as the device 10 described above). The contact charging pads of the device 50 may be used to charge a battery of the device 50 in a contact charging mode of operation, as discussed further below.

FIG. 6 is a cross-section of a system, indicated generally by the reference numeral 60, showing a device being charged in accordance with an example embodiment. More specifically, the system 60 shows the mat 40 being used to charge the device 50.

The cross-section of the system 60 shows contact charging points 43a, 43b, 43c and 43d that form part of the second row of contact charging points 43a to 43f described above. The device 40 is positioned such that the contact charging pad 52a is in contact with the contact charging point 43b and the contact charging pad 52b is in contact with the contact charging point 43c. Note that this connection can readily be reversed (so that the contact charging pad 52b is in contact with the contact charging point 43b and the contact charging pad 52a is in contact with the contact charging point 43c). Thus, the system 60 provides a great deal of flexibility.

The system 60 further comprises a charging arrangement 62 that is used to couple the 25 charging points 43b and 43c for charging the device 50, as discussed further below.

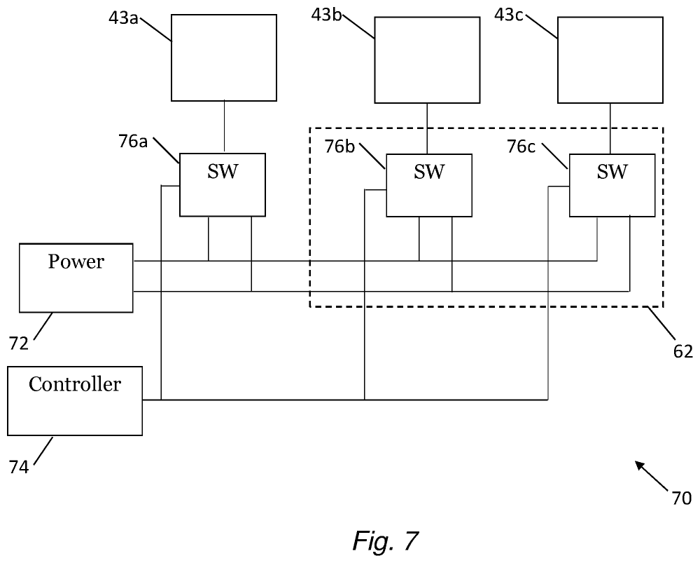

FIG. 7 is a block diagram of a system, indicated generally by the reference numeral 70, in accordance with an example embodiment. The system 70 is an example implementation of the contact charging mechanism 32 described above.

The system 70 includes the contact charging points 43a, 43b and 43c described above. The system 70 further comprise a power source 72, a controller 74, first, second and third switching modules 76a to 76c. As discussed further below, the second and third switching modules 66b and 66c and the second and third resistors 68b and 68c form the charging arrangement 62 described above. The power source 72 and the controller 74 are example implementations of the power source 36 and the control module 38 of the system 30 described above.

Clearly, multiple charging arrangements may be provided between the various combinations of contact charging points of the system.

The power source 72 and the controller 74 are both connected to each of the first to third switching modules 76a, 76b and 76c. The first switching module 76a is coupled to the contact charging point 43a. Similarly, the second switching module 76b is coupled to the contact charging point 43b and the third switching module 76c is coupled to the contact charging point 43c.

The controller 74 controls the switching modules so that power can be provided between pairs of contact charging points in order to charge a battery of a device (such as the device 50) that is in contact with the respective charging points. The controller 74 can also be used to ensure that the correct voltage magnitude and polarity is applied via the switching modules, according to the device being charged.

By way of example, the charging arrangement 62 can be controlled to activate the second switching module 76b and the third switching module 76c so that power from the power source 72 is provided across the contact charging points 43b and 43c so that the device 50 can be charged. Unused charging points are held at high resistance or at a safe voltage.

FIG. 8 is a block diagram of a system, indicated generally by the reference numeral 80, in accordance with an example embodiment. The system 80 comprises a wireless (e.g. radio frequency) charging mechanism 82 (which is an example implementation of the wireless charging mechanism 34 described above) and a device 84 to be charged (such as an aerosol generating device).

The wireless charging mechanism 82 comprises a power source 82a, a control module 82b and an antenna (or antenna array) 82c. The power source 82a and the control module 82b may be example implementations of the power source 36 and the control module 38 of the system 30 described above. The device 84 comprises a battery 84a, a control module 84b and an antenna (or antenna array) 84c.

The system 80 can therefore use the antenna 82c to transmit waves in the radio frequency spectrum. The antenna 84c can harvest energy in the transmitted waves for use in charging the battery 84a.

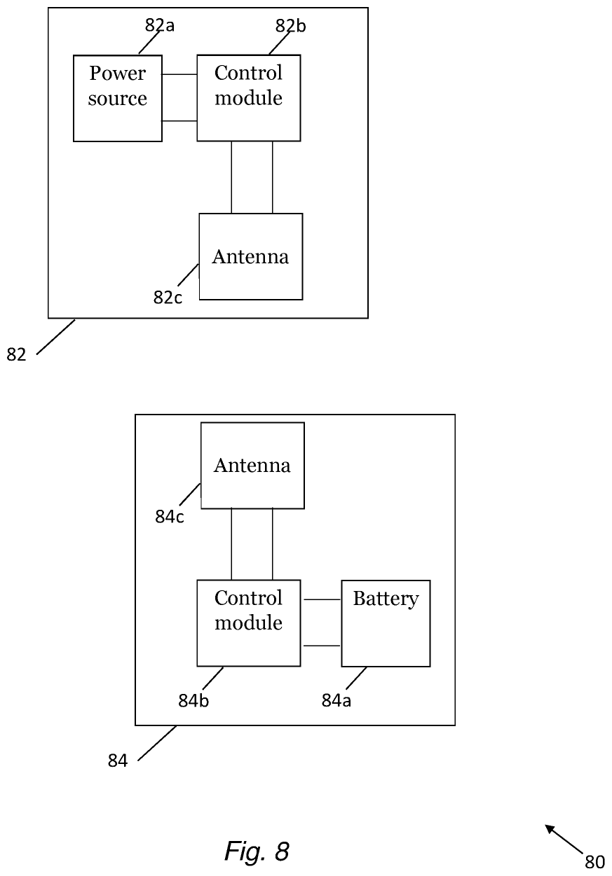

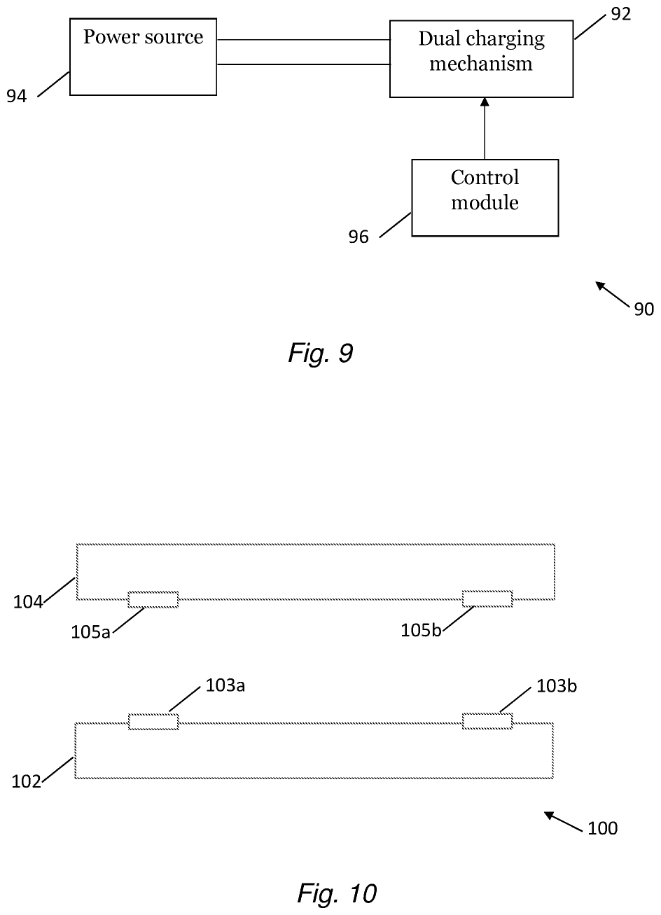

FIG. 9 is a block diagram of a system, indicated generally by the reference numeral 90, in accordance with an example embodiment. The system 90 comprises a dual charging mechanism 92, a power source 94 and a control module 96.

As discussed further below, the dual charging mechanism 92 comprises dual-charging pads that can be used as either contact charging pads or wireless charging pads. Accordingly, the dual charging mechanism 92 can be used to implement both the contact charging mechanism 32 and the wireless charging mechanism 34 of the system 30 described above.

The power source 94 provides power to the dual charging mechanism 92 and is therefore similar to the power source 36 described above. The control module 96 controls the operation of the dual charging mechanism 92 (e.g. by setting a charging mode of the dual charging mechanism to either a contact charging mode or a wireless charging mode of operation) and is therefore similar to the control module 38 described above.

FIG. 10 is a cross-section of a system, indicated generally by the reference numeral 100, in accordance with an example embodiment. The system 100 comprises a charging mechanism 102 (that has some similarities with the charging mat 40 described above) and a device for charging 104.

The charging mechanism 102 includes a first dual-charging pad 103a and a second dual-charging pad 103b that can be used as either contact charging pads or wireless charging pads.

Similarly, the device 104 includes first dual-charging pad 105a and a second dual-charging pad 105b that can be used as either contact charging pads or wireless charging pads.

In the system 100, the charging mechanism 102 and the device 104 are separated. The dual-charging pads 103a, 103b, 105a and 105b can be used as antennas in order for the system 100 to operate in the wireless charging mode. For example, the dual-charging pads 103a, 103b, 105a and 105b may be metal pads that can be operable as one or more antennas (in a wireless charging mode) and can be operable as one or more contact pads (in a contact charging mode). In some example embodiments, multiple dual-charging pads may be operated as a single antenna.

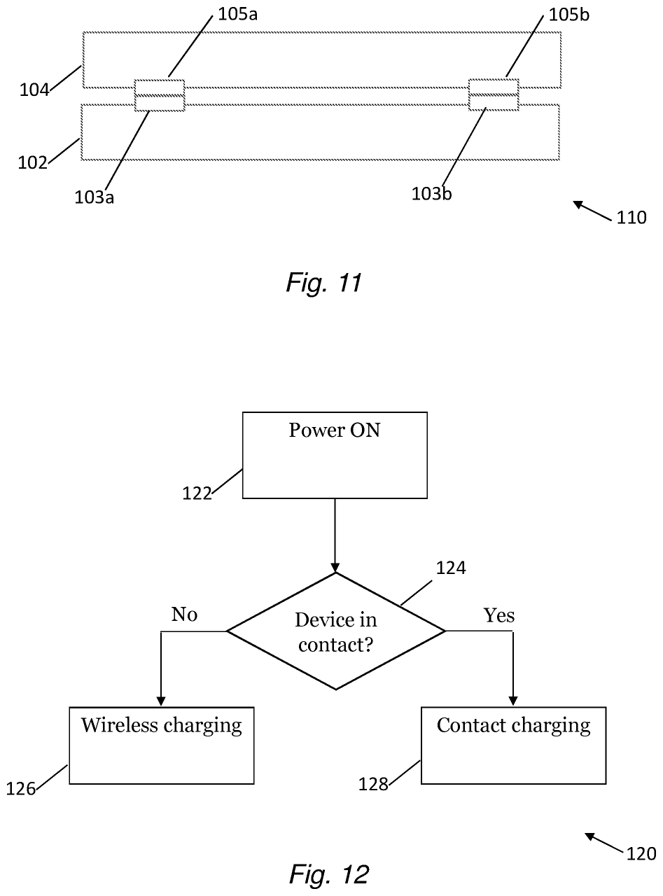

FIG. 11 is a cross-section of a system, indicated generally by the reference numeral 110, in accordance with an example embodiment. The system 110 comprises the charging mechanism 102 and the device for charged 104 described above.

In the system 110, the first and second dual-charging pad 103a and 103b of the charging mechanism are in contact with the first and second dual-charging pads 105a and 105b of the device 104. Thus, the dual-charging pads 103a, 103b, 105a and 105b can be used as contact charging pads (in a contact charging mode of operation).

In the systems 100 and 110, all of the charging pads are dual-charging pads. This is not essential to all example embodiments. For example, the charging mechanism 102 and/or the device 104 may comprise a plurality of contact charging pads, where one or more of the charging pads are dual-charging pads (for use as either contact charging pads or wireless charging pads). Further, the one or more wireless charging pads may be implemented using one or more (not necessarily all) of said dual-charging pads.

FIG. 12 is a flow chart showing an algorithm, indicated generally by the reference numeral 120, in accordance with an example embodiment.

The algorithm 120 starts at operation 122, where a power source (such as the power source 94 described above) is activated.

At operation 124, a determination is made regarding whether a device for charging (such as the device 104) is in contact with a charging mechanism (such as the charging mechanism 102).

If not, then the algorithm moves to operation 126, where a wireless (e.g. radio-frequency) charging mode is activated. If the device is in contact, then the algorithm moves from operation 124 to operation 128, where a contact-charging mode of operation is activated.

Thus, the algorithm 120 enables a determination to be made regarding whether a contact based charging mechanism or a wireless based charging mechanism of a dual-charging system should be used. This may repeated for every device allowing for multiple devices to be charged through either contact or wireless charging.

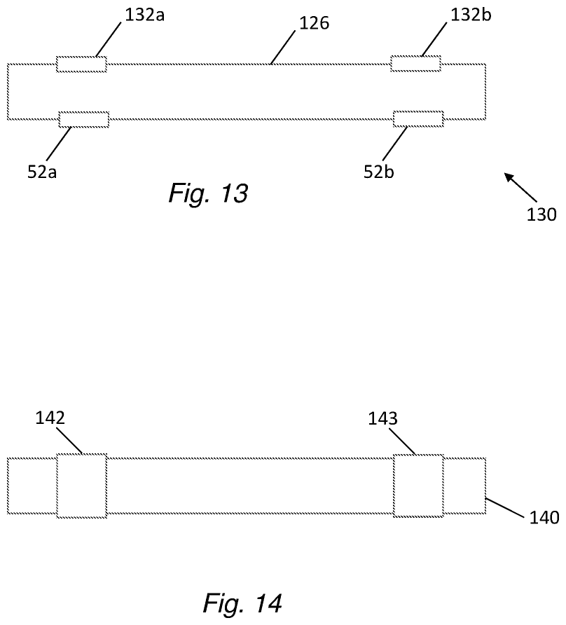

FIG. 13 is a block diagram of a device, indicated generally by the reference numeral 130, in accordance with an example embodiment.

The device 130 is an device (such as an aerosol generating device) similar to the devices 50 and 104 described above. The device 130 includes the pair of first contact charging pads 52a and 52b of the device 50. A pair of second contact charging pads 132a and 132b are provided on a second side of the device 130 substantially opposite to the first side. Thus, contact charging pads are accessible from both the first and second sides of the device 130. By providing contact charging pads on different sides of the device 130, the device can be charged in different orientations, which may be convenient for a user. In the example of FIG. 13, the device 130 is elongated and each of the pairs of contact pads 52a, 52b and 132a, 132b are provided at or adjacent to the respective ends of the device in the direction of elongation.

As discussed above, the first charging pads 52a and 52b of the device 120 may be arranged such that an area or point on each of the contact charging pads lie in or on a first common plane. Similarly, the second charging pads 132a and 132b may be arranged such that an area or point on each of the contact charging pads lie in or on a second common plane. Moreover, the device 130 includes a housing 136, wherein the housing lies below said common planes such that the contact charging pads are able to make contact with contact charging points of a charging mat or charging mechanism (such as the mat 40 or charging mechanism 102 described above).

FIG. 14 is a block diagram of a device, indicated generally by the reference numeral 140, in accordance with an example embodiment. The device 140 is an elongated device (such as an aerosol generating device) having a first side and a second side (which sides are opposite one another in the example device 140). A pair of contact charging pads 142 and 143 are provided that are accessible from both the first and second sides of the device 140. Specifically, the contact charging pads 142 and 143 are rings (e.g. split rings) that extend around the device 140.

The devices 50, 104, 130 and 140 described above are devices (e.g. elongated devices) having first and second sides. The cross-section of those devices may take many different forms.

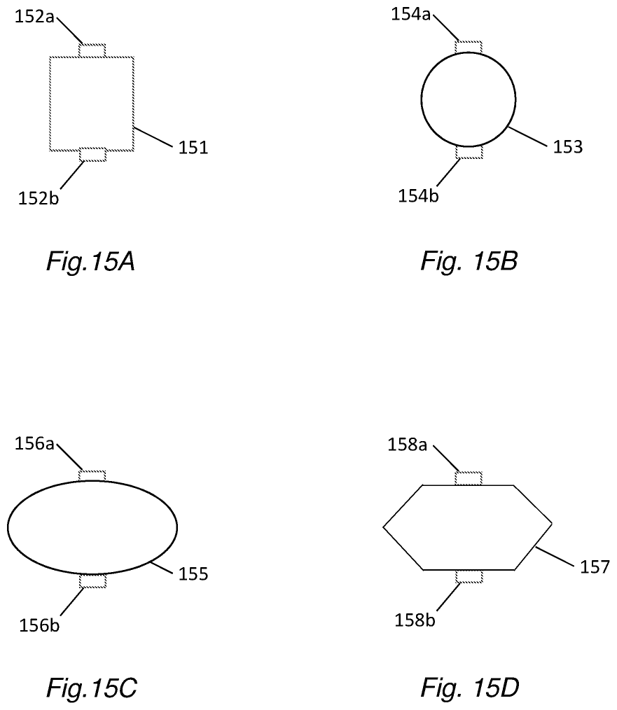

FIGS. 15A to 15D are cross-sections of devices in accordance with example embodiments.

FIG. 15A shows a device 151 having a square cross-section with a first contact charging pad 152a and a second contact charging pad 152b provided on opposite first and second sides of the device.

FIG. 15B shows a device 153 having a circular cross-section with a first contact charging pad 154a and a second contact charging pad 154b provided on opposite first and second sides of the device. Thus, the first and second sides of the device may form part of the same surface of the device, for example forming a cylindrical, pen-like device.

FIG. 15C shows a device 155 having an oval cross-section with a first contact charging pad 156a and a second contact charging pad 156b provided on opposite first and second sides of the device.

FIG. 15D shows a device 157 having a more complex cross-section with a first contact charging pad 158a and a second contact charging pad 158b provided on opposite first and second sides of the device.

Of course, the devices 151, 153, 155 and 157 are provided by way of example only. Many alternative cross-sectional shapes could be provided in alternative embodiments.

In addition to charging mechanisms, a device (such as the devices 50, 104, 130, 140, 151, 153, 155 and 157) may be configured to transmit data to and/or receive data via a contact based charging mechanism and/or a wireless charging mechanism. A separate means of communication may be used in conjunction with the wireless charging mechanism.

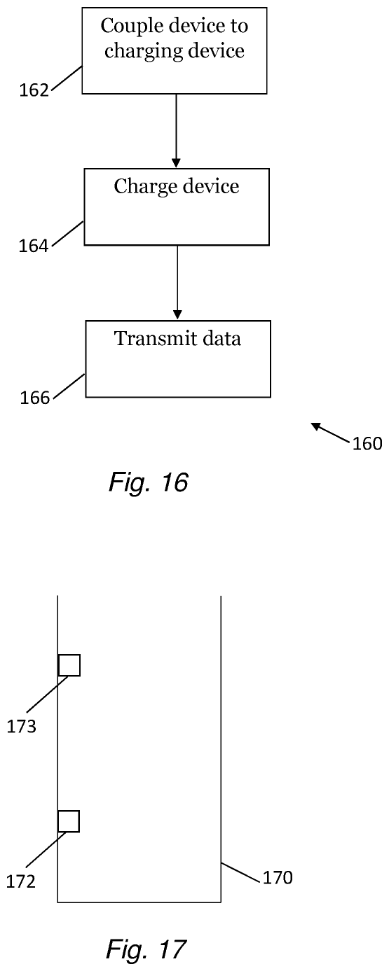

FIG. 16 is a flow chart showing an algorithm, indicated generally by the reference numeral 160, in accordance with an example embodiment.

The algorithm 100 starts at operation 162, where a device (e.g. an aerosol generating device) is coupling to a charging device for charging. For example, the device may be coupled to a contact charging device or to a wireless charging device.

At operation 164, the device coupled to the charging device is charged. As discussed above, in the case of contact charging, the operation 164 may be implemented by the switching modules of the system 70, under the control of the controller 74.

At operation 166, data is transmitted either by the device to be charged.

When the algorithm 160 is complete, the device may be decoupled from the charging device in some way.

As discussed above, charging contact points may be provided as part of a charging mat. This is not essential to all example embodiments. Charging points may be provided in many different ways.

FIG. 17 is a block diagram of a charging device 170 in accordance with an example embodiment. The charging device 170 is shaped to enable a device, such as the devices 50, 104, 130, 140, 151, 153, 155 and 157 described above, to be retained within the device 170. The charging device 170 includes a first contact charging point 172 and a second contact charging point 173 for coupling with contact charging pads of a device for charging. In use. The charging device 170 may be placed on a user's desk to enable convenient charging of a device. One or more of the first and second contact charging points 172 and 173 may be dual-charging points that are operable as either contact charging points or radio-frequency charging points.

Of course, the mat 40 and the charging device 170 are provided by way of example only. Many variants are possible.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A non-combustible aerosol provision device comprising:
circuitry for controlling the supply of power within the aerosol provision device;
a contact-based charging mechanism for coupling with a contact charging device for contact charging of the aerosol provision device; and
a wireless charging mechanism for coupling with a wireless charging device for wireless charging of the aerosol provision device,
wherein the circuitry is configured to control the supply of power within the aerosol provision device received via the contact-based charging mechanism and via the wireless charging mechanism.

2. A device as claimed in claim 1, wherein the contact-based charging mechanism comprises at least two first contact charging pads for coupling with a contact charging device, and wherein the wireless charging mechanism comprises at least one wireless charging pad for coupling with a wireless charging device.

3. A device as claimed in claim 2, wherein:
one or more of said the first contact charging pads are dual-charging pads for use as either contact charging pads or wireless charging pads; and
the at least one wireless charging pad is implemented using one or more of said dual-charging pads.

4. A device as claimed in claim 3, wherein the dual-charging pads are metal pads that are operable as one or more antennas.

5. A device as claimed in claim 2, wherein the at least two first contact charging pads are provided on a first side of the device.

6. A device as claimed in claim 5, further comprising at least two second contact charging pads provided on a second side of the device.

7. A device as claimed in claim 5, wherein the first contact charging pads are accessible from both the first side of the device and a second side of the device.

8. A device as claimed in claim 6, wherein the first side is substantially opposite the second side.

9. A device as claimed in claim 6, wherein the first and second sides of the device form part of the same surface of the device.

10. A device as claimed in claim 1, wherein the device is configured to transmit data via one or more of said charging mechanisms.

11. A device as claimed in claim 10, wherein said data is transmitted using a data over power protocol.

12. A device as claimed in claim 1, wherein the wireless charging mechanism is a radio frequency charging mechanism.

13. A device as claimed in claim 12 when dependent on any of claims 2 to 11, wherein the one or more first wireless charging pads are radio frequency charging pads for coupling with a radio frequency charging device for radio frequency charging of the device.

14. A charging device comprising:
a contact-based charging mechanism for coupling with a first device for contact charging of the device in a contacting charging mode;
a wireless charging mechanism for coupling with a second device for wireless charging of the device in a wireless charging mode; and
a control module configured to set a charging mode of the charging device to the contact charging mode or the wireless charging mode.

15. A charging device as claimed in claim 14,
wherein said contact-based charging mechanism comprises at least two charging points for coupling with at least two contact charging pads of the first device.

16. A charging device as claimed in claim 15, wherein said contact-based charging mechanism comprises a mat having a plurality of contact charging points for coupling with charging pads of the first device.

17. A charging device as claimed in claim 15, wherein the control module is configured to determine whether a device is in contact with at least two charging points of the contact-based charging mechanism and to set the charging mode accordingly.

18. A charging device as claimed in claim 14, wherein said wireless charging mechanism comprising one or more first wireless charging pads.

19. A charging device as claimed in claim 14, further comprising one or more dual-charging pads for use during contact of the device in the contact charging mode and for use during wireless charging of the device in the wireless charging mode.

20. A charging device as claimed in claim 19, wherein the dual-charging pads are metal pads that are operable as one or more antennas.

21. A charging device as claimed in claim 14, wherein the wireless charging mechanism is a radio frequency charging mechanism for coupling with the second device for radio frequency charging of the device.

22. A method comprising:
determining whether a contact based charging mechanism of a charging device having the contact-based charging mechanism and a wireless charging mechanism is configured for contact charging of a device for charging and, if so, enabling a contact-based charging mode of operation of the charging device.

23. A method as claimed in claimed in claim 22, further comprising:
enabling a wireless charging mode of operation of the charging device in the event that the wireless charging mechanism is not configured for contact charging the device for charging.

24. A method as claimed in claim 22, further comprising:
determining whether the wireless charging mechanism of the charging device is configured for charging of the device for charging and, if so, enabling a wireless charging mode of operation of the charging device.

25. A method as claimed in claim 22, wherein said charging device comprises dual-charging pads for use as either contact charging pads or wireless charging pads.

26. A method as claimed in claim 22, further comprising transmitting data to and/or receiving data from the device for charging via said contact based charging mechanism and/or the wireless charging mechanism.

27. A computer program product comprising instructions for causing an apparatus to perform:
determining whether a contact based charging mechanism of a charging device having the contact-based charging mechanism and a wireless charging mechanism is configured for contact charging of a device for charging and, if so, enabling a contact-based charging mode of operation of the charging device.
